(19) United States
(12) Patent Application Publication
(10) Pub. No.: US 2007/0262174 A1
(43) Pub. Date: Nov. 15, 2007

(54) Particulate injector system for spray layup

(75) Inventors: Mike Akin Oden, Littlefield, TX (US); David Lee Peacock, Mexico, MO (US)

Correspondence Address: Elizabeth R. Hall & Associates, P.C., 1722 Maryland Street, Houston, TX, 77006-1718, US

(73) Assignee: Impact Composite Technology, Ltd., Houston, TX (US)

(21) Appl. No.: 11/544,843

(22) Filed: Oct. 6, 2006

Related U.S. Application Data
(60) Provisional application No. 60/799,159, filed on May 10, 2006.

(51) Int. Cl. B05B 7/06

(52) U.S. Cl. 239/428; 239/422

(57) ABSTRACT

The particulate injection system of the present invention uses a pneumatically operated system to deliver particulate or filler material to the nozzle of a modified chopper type spray gun for making sprayed layups of reinforced plastic parts. The filler injection system delivers the filler material directly into the flow stream from the spray gun, thereby permitting a homogeneous admixture of the particulate matter with the stream of resin and chopped reinforcing fibers from the spray gun.

### CROSS REFERENCE TO RELATED APPLICATIONS

The present application, pursuant to 35 U.S.C. 111(b), claims the benefit of the filing date of provisional application Ser. No. 60/799,159 filed May 10, 2006 and entitled “Particulate Injector System for Spray Layup.”

### BACKGROUND OF THE INVENTION

1. Field of the Invention

The present invention relates in general to a method and apparatus for preparing plastics reinforced with particulate material. More particularly, the invention relates to a method and apparatus for injecting particulate material into the flow stream of a spray gun used for making sprayed layups of reinforced plastic parts.

2. Description of the Related Art

The fiberglass reinforced plastics industry produces a variety of products including shower stalls, bathtubs, spas, skis, boats, camper tops, corrosion resistant tanks, etc. The most common method of reinforced plastics production is open molding. First the surface of the mold is polished and coated with a wax, which allows easy removal of the finished product from the mold after curing. Then a gel coat (a mixture of unsaturated polyester resin, catalyst and pigments) is sprayed onto the waxed mold to form the outer, visible surface of the finished product.

After the gel coat is fully cured, fiberglass reinforcing material saturated with catalyzed polyester resin is sprayed into the mold. The polyester resin, catalyst, and fiberglass strands are fed into a chopper gun for spraying. The chopper gun is so named because it chops the fiberglass into short segments, mixes those segments into the resin stream, and sprays that fiberglass resin mixture into the mold. One problem that plagues the fiberglass reinforced plastics industry in the large amount of styrene, a major environmental pollutant, emitted during the application or spraying stage of the process.

There is a continuing need to find ways of improving fiberglass reinforcing materials, as well as reducing the environmental impact of the process.

### SUMMARY OF THE INVENTION

The invention contemplates a method and apparatus for injecting particulate material into the resin flow of a spray gun to make spayed layups of reinforced plastic parts.

The present invention provides for the adjustable flow of particulate material into reinforced resin through the coordinated controlled use of a venturi and a feed auger. Furthermore, the present invention makes use of a preset, fixed orifice to regulate the feed of the bulk particulate material to the spray gun. In addition the present invention provides a return line for conveying any excess particulate material back to the storage hopper.

One aspect of the present invention is an apparatus for spraying particulate matter and resin comprising: (a) an air supply; (b) a particulate feed system having an air motor in communication with the air supply, an auger rotated by the air motor, a supply tank feeding a particulate material into the auger, and a venturi nozzle, wherein rotation of the auger delivers the particulate material to the venturi nozzle and the particulate material emanates from the venturi nozzle; and (c) a spray gun delivering a resin stream and a stream of the particulate material.

Another aspect of the present invention is an apparatus for spraying reinforced plastic resin comprising: (a) an air supply; (b) a filler feed system having an air motor in communication with the air supply, an auger rotated by the air motor, a filler supply tank feeding a filler material into the auger, and a venturi nozzle, wherein rotation of the auger delivers the filler material to the venturi nozzle and the filler material emanates from the venturi nozzle at a rate controlled by a rate of rotation of the auger and the venturi air supply pressure; and (c) a spray gun delivering a resin stream, a chopped glass stream, and a stream of filler material.

Yet another aspect of the present invention is an apparatus for spraying particulate matter and resin comprising: (a) an air supply; (b) a particulate feed system having an air motor in communication with the air supply, an auger rotated by the air motor, a supply tank feeding a particulate material into the auger, and a venturi nozzle, wherein rotation of the auger delivers the particulate material to the venturi nozzle and the particulate material emanates from the venturi nozzle; and (c) a spray gun delivering a resin stream and a stream of the particulate material, the spay gun comprising a spray gun body, a mixing head, a spray nozzle in communication with the mixing head, and a particulate injection nozzle in communication with the venturi nozzle; and (d) a control means for controlling the delivery of the stream of the particulate material by controlling a rotation rate of the auger and a venturi air supply pressure.

Still yet another aspect of the present invention is a process for spraying reinforced plastic resin using an apparatus for spraying particulate matter and resin comprising: (a) an air supply; (b) a particulate feed system having an air motor in communication with the air supply, an auger rotated by the air motor, a supply tank feeding a particulate material into the auger, and a venturi nozzle, wherein rotation of the auger delivers the particulate material to the venturi nozzle and the particulate material emanates from the venturi nozzle; and (c) a spray gun delivering a resin stream and a stream of the particulate material, the spay gun comprising a spray gun body, a mixing head, a spray nozzle in communication with the mixing head, and a particulate injection nozzle in communication with the venturi nozzle; and (d) a control means for controlling the delivery of the stream of the particulate material by controlling a rotation rate of the auger and a venturi air supply pressure.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a side profile view of a first embodiment of the present invention, showing the feed and control systems in the mounting frame;

FIG. 2 is an oblique view corresponding to FIG. 1 showing the feed and control systems;

FIG. 3 is an oblique view from above and to one side of the feed system of FIG. 1, wherein the mounting frame is omitted for clarity;

FIG. 4 is a vertical cross-sectional view of the feed system of the overall system shown in FIG. 1 taken through the feed tube and its auger;

FIG. 5 is a longitudinal vertical cross-sectional view of the induction system of the present invention;

FIG. 6 is a longitudinal vertical cross-sectional view of the induction system of the present invention transverse to that of FIG. 5 and with the delivery elbow attached with the flow restrictor orifice plate installed;

FIG. 7 is an oblique view of a first type of spray gun adapted for use with the present invention;

FIG. 8 is an oblique view of a second type of spray gun adapted for use with the present invention, wherein a velocity booster tube is provided for enhancing the feeding of the particulate material;

FIG. 9 is a schematic diagram of the pneumatic system of the present invention;

FIG. 10 is an oblique view of a third embodiment of the spray gun adapted for use with the present invention, wherein the fiberglass chopper gun is omitted and particulate material is delivered to the resin stream; and

FIG. 11 is an oblique view of a fourth embodiment of the spray gun adapted for use with the present invention, wherein the fiberglass chopper gun is omitted and a velocity booster tube is provided for enhancing the feeding of the particulate material to the resin.

### DESCRIPTION OF THE PREFERRED EMBODIMENTS

The particulate, or filler, injection system of the present invention uses a pneumatically operated system to deliver particulate matter such as fine grained flaked bulk particulate material, also referred to herein as filler material, to the nozzle of a modified chopper type spray gun for making sprayed layups of reinforced plastic parts. The particulate injection system delivers the particulate material directly into the flow stream from the spray gun, thereby permitting a homogeneous and intimate admixture of the particulate material with the stream of resin.

The particulate or filler material used in the spray gun includes a number of materials such as natural fibers, chopped glass, or a mixture of various materials. The injection system of the present invention functions either with or without a chopper gun. Thus whenever fiberglass is added to the reinforced plastic, it can thus be sprayed as prechopped glass into the flow stream from the spray gun or it can be added to the flow stream from a chopper gun.

The preferred particulate or filler material is a natural fiber such as wood fiber or agricultural fibers such as flax, kenaf, hemp, jute, peanut, or cotton hull fibers. A particularly suitable material for this process is Renfil™, a mechanically modified residue of cotton plants produced during the stripping of the cotton bolls at harvest. Renfil™ is manufactured and distributed by Impact Composite Technology, Ltd., Houston, Tex.

Renfil™ is a particularly good filler material for the described process because of its high lignin content. Due to the highly absorbent nature of the Renfil™ and the speed of the chemical reaction of its lignin with the styrene emitted from the resin, the resultant uniform mixture of Renfil™ filler with a resin stream permits the filler to absorb most of the styrene present in the resin. For this reason, the particulate injection system of the present invention markedly reduces the amount of styrene released to the atmosphere during the spray operation.

Typically, the components of the particulate injection system 10 are made of steel, unless otherwise noted. For example, the feed auger 35 is constructed of a polymer material for both wear resistance and flexibility. Seals, gaskets, and hoses are generally made of elastomeric materials.

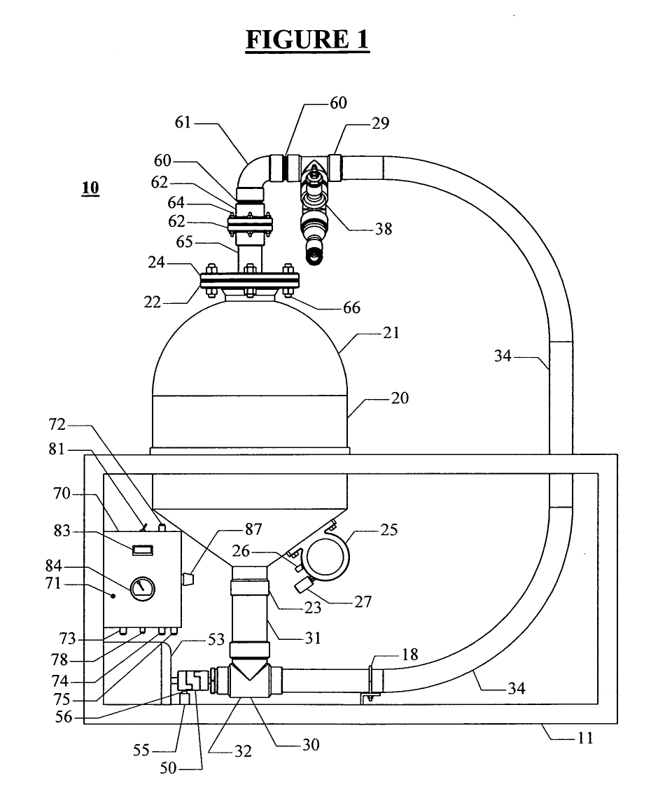

Referring to FIGS. 1-3, the first embodiment 10 of the present invention is shown. As shown therein, the feed system 20 is mounted in a welded steel perimeter frame 11 constructed of structural angles and plate. The perimeter frame 11 serves to support and protect the components of the feed system 20. The upper end of the tank 21 of the feed system extends above the top of the frame 11 in order to provide ready access to the upper flange 22 on the top of the tank so that particulate matter or filler can be added to the tank.

A transverse steel mounting plate 12 flush with the bottom of the frame 11 extends from one transverse side of the frame to the other adjacent to a first end of the frame. Spaced a short distance away from the opposed second end of the frame 11 is a transversely mounted support angle 13 which extends from one transverse side of the frame to the other at the bottom of the frame. Circular tank support ring 14 is attached to the upper side of frame 11 and laterally supports tank 21. Tank 21 is a slip fit inside ring 14.

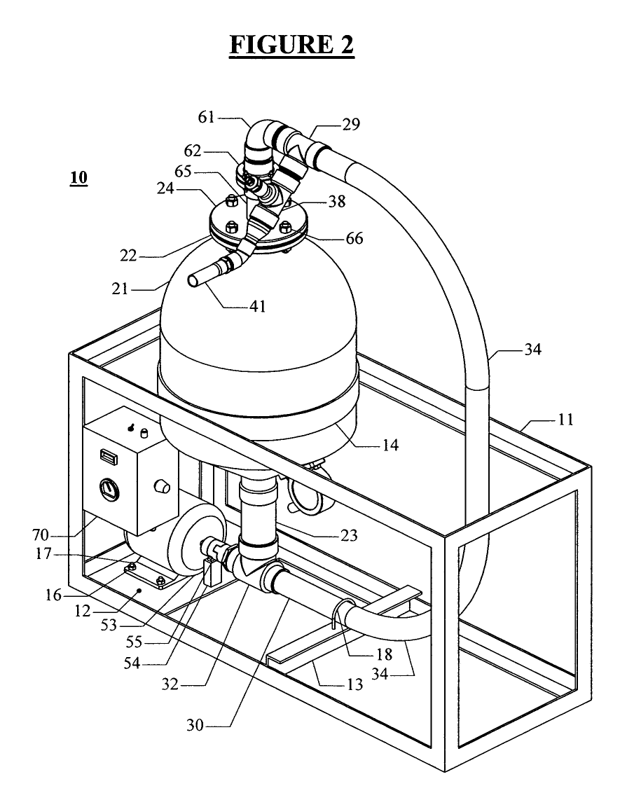

Angle 13 has one leg horizontal on its upper side. Both mounting plate 12 and support angle 13 are provided with appropriately positioned mounting holes or other attachment means for the mounting of the feed system 20. As shown in FIG. 2, the motor 53, used to drive the feed auger 35 of the feed system 20, is mounted to plate 12 by means of threaded studs 17 and comated nuts 16. Motor 53 is shown as a pneumatic motor, but an explosion-proof electric motor with a gear reducer or a hydraulic motor readily may be substituted. The vertically upwardly projecting studs 17 are welded to the plate 12 in an array positioned to engage holes in the mounting foot of the air motor 53. The angle 13 is engaged with the second pipe segment 34 at one end of the feed auger system 30 using a U-bolt 18 and threadedly engaged attached nuts.

The tank 21 has a vertical axis and has a right circular cylindrical middle section, a frustroconical lower section decreasing in diameter downwardly, and a hemispherical upper section. A relatively large bore tubular neck 23 having female pipe threads on its lower end extends downwardly from the lower end of the lower, frustroconical portion of the tank. By way of example, the tubular neck might be a nominal 3 inch pipe and the female threads 3 inch NPTF (National Pipe Thread Female).

Centrally located on the upper end of the upper, hemispherical end of the tank is a central hole with an upwardly facing flange 22. Cover flange 24 comates with the flange 22 of the tank 21 so that the tank may be sealed using a flat gasket (not shown) and nutted studs 66 when desired. Cover flange 24 is provided with an upwardly extending integral coaxial tubular neck 65. The upper end of tubular neck 65 has a male pipe thread which is used to threadedly engage and mount an upwardly facing terminal flange fitting 62. The Renfil™ or other filler compound is inserted into the tank 21 through the upper flange 22 of the tank and is discharged into the feed auger system 30 through the tubular neck of the tank.

Rigidly mounted on the lower exterior side of the tank 21 is a pneumatic vibrator 25 that is used to ensure that the filler in the tank will feed smoothly into the tubular neck of the tank 21 and thence into the feed auger system 30. The vibrator 25 is supplied with pressurized air for power through an air line (not shown) from the vibrator supply fitting 74 of the control system 70 to the inlet 26 of the vibrator. The exhaust from the vibrator 25 passes through a muffler 27 in order to reduce operating noise levels.

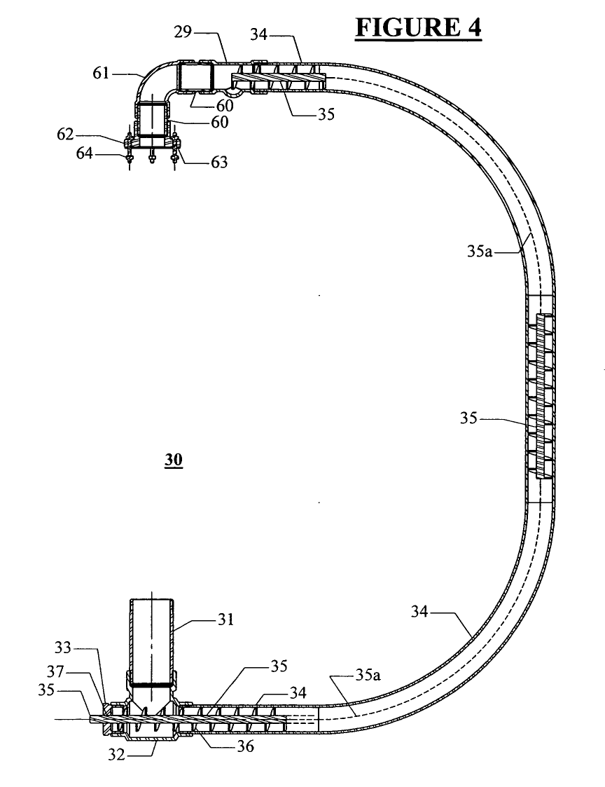

The feed auger system 30, shown in FIG. 4, is generally constructed primarily from commercially available piping components, such as steel components based on a 2-inch NPT (National Pipe Thread) thread pattern. A vertical first long pipe nipple 31 is threadedly engaged at its upper end with the female thread on the tubular neck 23 of the tank 21. The thread at the bottom end of the nipple 31 is threadedly engaged with the upwardly extending non-through socket bore of the first female pipe tee 32.

The pipe tee 32 has its through bore horizontal and, at its outlet end which is shown on the right in FIGS. 1 to 4, is threadedly engaged with a nonlinear second long pipe segment 34. Second pipe segment 34 has a constant inner diameter and consists of, from its lower end, a first relatively short horizontal linear segment, a first large radius elbow, a second vertical linear segment, a second large radius elbow, and a final short horizontal linear segment having male threads at its distal end. The male threads at the upper distal end of second pipe segment are threadedly connected to female tee connection 29. The second pipe segment 34 has most of its segments in a common vertical plane. At the other horizontal end of tee 32 opposed to the outlet end, modified hex pipe plug 33 is threadedly engaged. Modified plug 33 is typically a standard hex pipe plug with a coaxial through bore which serves as a support journal 37 for the shaft of auger 35.

Feed auger 35 has a flexible elongate cylindrical shaft with a single helically spiraled radially projecting feed auger flute 36 attached. The shaft of feed auger 35 is conformable to the bends of the second pipe segments 34 and extends through the entire length of the second pipe segment, as indicated in FIG. 4 by dashed line 35a.

Typically, feed auger 35 is constructed of a relatively flexible wear resistant material, such as high density polyethylene. The auger flute 36 is a loose fit inside the bore of the second pipe segment 34. The auger flute 36, as seen in FIG. 4, starts approximately 1 to 2 inches from the lefthand end and extends within the bore of the second long pipe segment 34 up to the vicinity of the second female pipe tee 29 where the upper end of the second pipe segment 34 is threadedly connected. The unfluted end of the auger 35 is journaled in the auger shaft support journal 37 and extends beyond the pipe plug 33, where it is attached to a shaft coupling 50.

The transverse outlet of the female second pipe tee 29 is inclined downwardly at 45 degrees from the horizontal. A short male pipe nipple 44 of the injector nozzle 38 is threadedly engaged in the inclined nonthrough outlet of tee 29 and on its other end threadedly engages the first through outlet of female third pipe tee 39 of the injector nozzle 38.

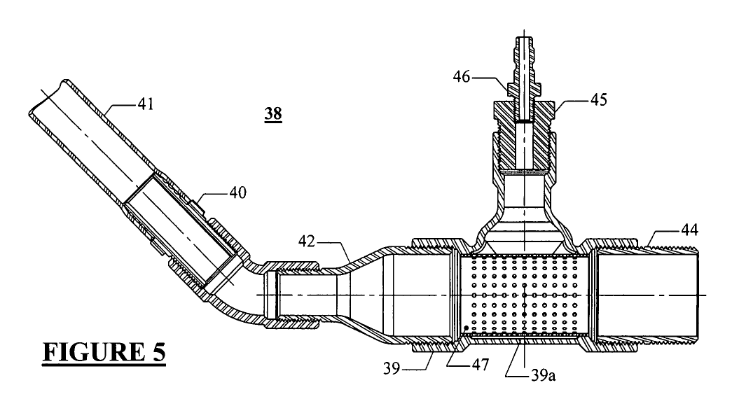

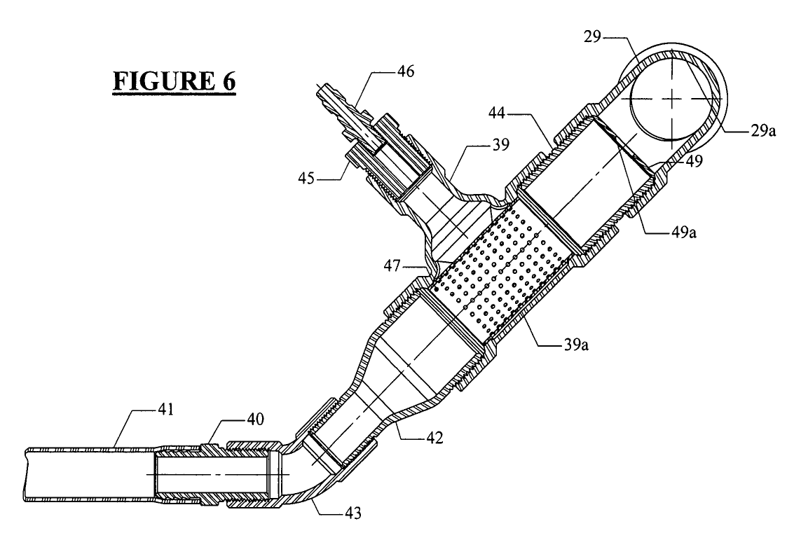

Referring to FIGS. 5 and 6, the injector nozzle 38 of the first embodiment of the filler injector system 10 consists of the third female pipe tee 39 onto which are mounted the other components of the nozzle. The third female pipe tee 39 has an upwardly extending 1 inch NPT female non-through bore threadedly engaged with a special nozzle fitting 45. Special nozzle fitting 45 has a hex head and a 1 inch NPTM male thread. The special nozzle fitting 45 has a coaxial through bore and a tapped female thread on the exterior end of its through hole, where male quick connect fitting 46 is threadedly engaged. Male quick connect fitting 46 is threaded into the exposed hex end of fitting 45 so that a hose quick connection (not shown) can be established readily for the purpose of inducing air flow through the coaxial hole in the fitting. The two coaxial through bores of third tee 39 preferably have 2 inch female NPT threads. The through bore of third tee 39 is slightly restricted adjacent the inner ends of the threads at its outer ends, while the central portion of the bore is slightly relieved when it is intersected by the nonthrough bore of the tee.

A thin wall right circular cylindrical sleeve 47 having an array of radial through holes in the central portion of its length is pressed with a sealing light interference fit into both the restricted portions of the through bore of third tee 39. A porous annular interior cavity 39a is thus formed between the outer wall of sleeve 47 and the central interior through bore of third tee 39. The cavity 39a communicates with the nonthrough bore of the third tee 39 and, through the radial holes in sleeve 47, with the through bore of the sleeve and the tee. The through holes are preferably regularly spaced.

Threadedly engaged in the second through outlet end of third tee 39 and proceeding in sequential order from that tee are a male reducer nipple 42, a 45 degree female elbow 43, and a male crossover hose fitting 40. These fittings 39, 42, 43 and 40 are all threadedly engaged. The reducer nipple 42 typically has a 2 inch NPT thread on a first end and a 1 inch NPT thread on a second end. The elbow 43 is aligned so that the outlet of hose fitting 40 is horizontal. Hose fitting 40 typically has a 1 inch male NPT thread at one end and a hose barb at its other end. Pneumatic pressure hose 41 is mounted on the hose barb of hose fitting 40 and serves to convey air with entrained filler from the feed system 20 to the spray gun 100 or 200. In order to avoid static electrical discharges, hose 41 may be made of conductive material.

Air injected into the cavity 39a of the third tee 39 from the quick connect fitting 46 passes through the radial holes in the sleeve 47 and is accelerated into the bores of the reducer nipple 42, the elbow 43, the fitting 40 and into the hose 41 at a very high velocity, thereby creating a venturi effect within the bore of the sleeve of the tee 39. The resultant vacuum draws filler material delivered to the second tee 29 by the auger 35 through hole 49a of restrictor orifice plate 49 and into the injector 38.

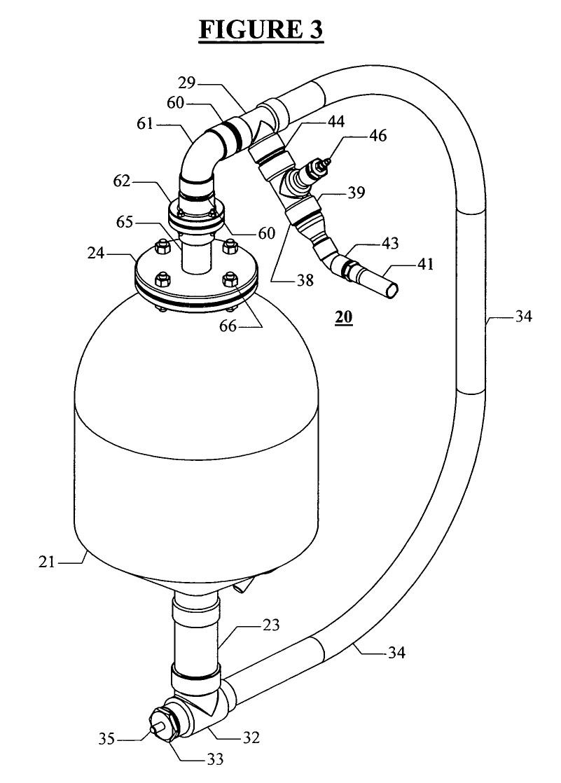

Referring back to FIGS. 3 and 4, it is seen that the through outlet end of second pipe tee 29 of the feed auger system 30 is provided with a return line to the tank 21 so that excess flow of the filler material delivered by the auger 35 can be returned. Sequentially from the connection with the second tee 29, the return line consists of a close pipe nipple 60, a 90 degree female elbow 61, another pipe nipple 60, and a flanged terminal fitting 62. The flanged terminal fitting 62 is provided with a flat gasket 63 and multiple connector stud/nut sets 64. The downwardly facing flanged terminal fitting 62 of the feed auger system 30 is comatable with the upwardly facing flanged terminal fitting 62 of the lid flange 24.

Shaft coupling 50 serves to connect the feed auger 35 to air motor 53 so that the auger can be driven thereby. Coupling 50 consists of two identical coupling jaws separated both axially and between their intermeshed jaws by an elastomeric flex element. Each coupling jaw has one or more radially mounted set screws to fix the jaws to their respective mounting shafts in order to prevent relative rotation between the jaws and shafts. As shown, air motor 53 is not provided with reduction gearing, but in some cases such gearing may be desired. The air motor 53 is supplied with air from the control system 70 by means of an air motor supply fitting 73 and a connecting hose (not shown). Rotation of the air motor 53 causes the auger 35 to be rotated within the bore of the feed auger system 30, thereby inducing filler passing down first long pipe nipple 31 to be urged toward the injection nozzle 38.

Air motor 53 is mounted by means of threaded studs 17 and nuts 16 to the mounting plate 12 of frame 11. A rectangular metal block 55, mounted below the inwardly projecting jaw of the shaft coupling jaws, supports a RPM switch 56. The RPM switch 56 is of either the Hall effect type or a magnetic proximity sensor, so that an electrical pulse is generated each time a jaw of the steel shaft coupling 50 passes the switch. These electrical pulses are conveyed by a pair of wires to the auger RPM meter display 83 mounted on the front face of the control box 71 of the control system 70.

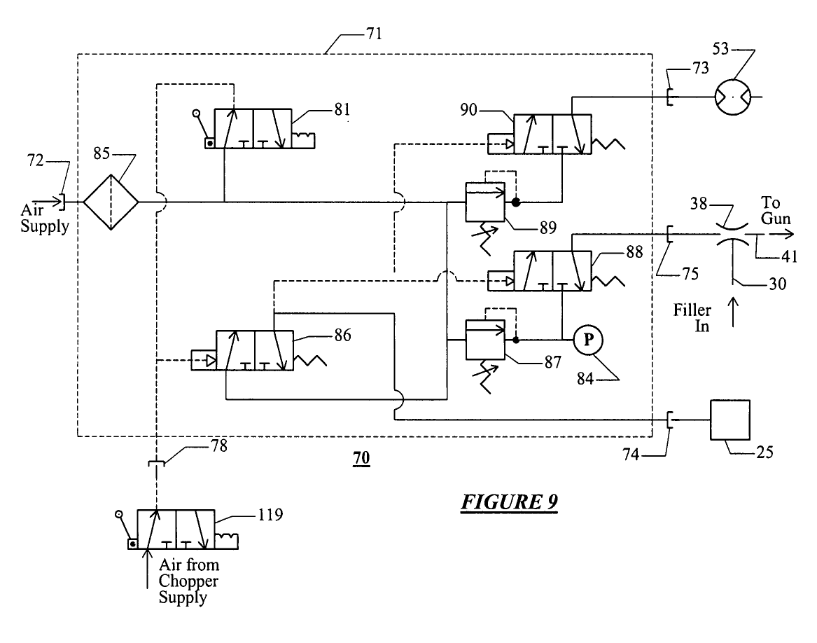

Control system 70, housed in rectangular prismatic control box 71, uses pneumatic control in order to provide power and control to the filler injector system 10. Control box 71 is positioned within the perimeter of frame 11, as shown in FIGS. 1 and 2. FIG. 9 shows a schematic of the control system 70. Control system 70 is used to provide air to operate the vibrator 25, the air motor 53 which drives the auger 35, and the injection nozzle 38.

Air to operate the control system 70 and its dependent controlled equipment is provided through shop air delivered through air supply inlet fitting 72. This incoming air supply is filtered by filter 85 upon entry into the control system. The incoming air supply is directly routed to the manual override valve 81, the first piloted valve 86, the venturi pressure regulator 87, and the motor pressure regulator 89. Motor pressure regulator 89 is mounted inside the control box 71, while the control knob of venturi pressure regulator 87 extends through the side of the box 71 for ready operator access.

Manual override valve 81 is a two-position three-way detented valve operated by a toggle switch that protrudes from the upper surface of the control box 71. A pneumatic pressure signal from the gun signal trigger 102, mounted on the spray gun 100, is routed to the control system 70 by means of a signal tube (not shown except in FIG. 9) and enters the control system through a gun feedback inlet fitting 78. The pressure signals from the valves 103 and 81 are combined by means of interconnecting the outputs from those valves to provide a pilot pressure for first piloted valve 86. Thus, the pilot signals from either selectably controllable gun trigger 103 or valve 81 or both serve to operate valve 86. Accordingly, valve 86 serves as an OR logic gate.

The output from first piloted valve 86 provides operational air to the vibrator 25 by way of vibrator supply fitting 74 and a supply hose (not shown). Additionally, the output from valve 86 serves as a pilot signal for both the second 88 and the third 90 piloted valves. All three piloted valves 86, 88, and 90 are 2-position 3-way normally closed valves with single-acting pneumatic pilots and spring returns. Pressure regulators 87 and 89 respectively control the inlet air pressure to valves 88 and 90, which in turn respectively control the air delivery to operate the venturi nozzle 38 and the air motor 53. Pressure gauge 84, mounted on the cover of control box 71, is used to indicate the inlet pressure for valve 88 and the venturi nozzle 38. The air supply for the venturi nozzle 38 is delivered from valve 88 via venturi supply fitting 75 and a hose (not shown). The air supply for the air motor 53 is delivered from valve 90 via air motor supply fitting and a hose (not shown).

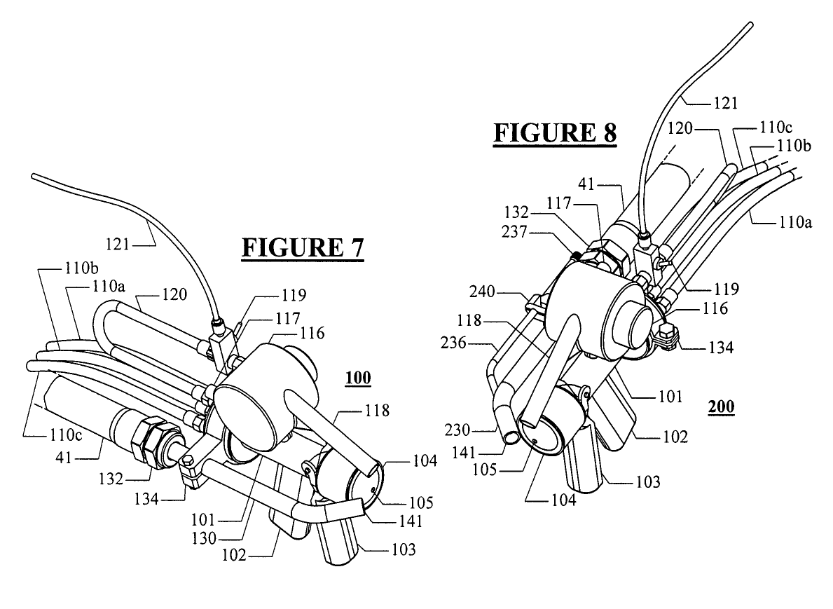

A first embodiment of a spray gun 100, shown in FIG. 7, is based on a conventional commercially available non-atomizing spray gun. A wide variety of commercially available guns are used for spray layup of reinforced plastics; the spray gun 100 of this system is produced by adding a clamp-on filler injection tube 130 to such guns. The first spray gun embodiment 100 and the second spray gun embodiment 200 are configured to be used with a gun-mounted chopper gun 116 for adding chopped fiberglass to the resin stream.

The typical spray gun 100 has a spray gun body 101 which normally has axially aligned stepped cylindrical body segments, a handle 102 projecting in a radial plane, and a trigger 103 attached to the body at one end and rotatable in the same plane of the body defined by the handle. Air, resin, and catalyst are respectively supplied to the rear of the gun 100 by means of hoses 110a,b,c. The hoses 110a,b,c are connected to the rear of the body 101 or gun 100 by threading their end fittings into threaded ports. The threaded ports connect to internal passages and are routed to the mixing head 104 of the body 101 through the flow controlling valving mechanisms of the trigger 103.

The resin and catalyst are combined in the mixing head 104, located at the front of the body 101, and are ejected from the mixing head by means of one or more spray nozzles 105. The resin spray pattern of the gun 100 is substantially coaxial with the cylindrical body segments of the body 101 of gun 100. Since the particular mechanisms of the spray gun control are not part of the present invention and are well known to those skilled in the art, they are not described in detail herein.

Integral with and mounted by means of a pedestal on the top of the spray gun 100 in the same vertical plane as the handle 102 but on the upper side of the body 101 is a chopper 116. The chopper 116 is pneumatically driven and serves to cut an incoming skein of fiberglass into short lengths. The chopper 116 has a body consisting of two concentric right circular cylinders, with the larger cylinder centered on the pedestal perpendicular to the plane of the handle 102. A radial port 117 on the rear portion of the body of chopper 116 admits the fiberglass skein into the chopper, while an outlet tube 118 carries the cut fiberglass to a point adjacent the outlet spray nozzle 105 of the mixing head 104 of the gun 100.

A two position on-off valve 119 with a toggle switch is used to control the operation of the chopper 116. The air supply for the chopper 116 is provided from the rear of the body 101 of the spraygun to the rear of the chopper by U-shaped chopper hose 120. A signal hose 121 from a tee connection of the chopper on-off valve 118 is used to activate the feed mechanism (not shown) for the fiberglass skein.

The filler injection tube 130 is a length of plastically deformable metallic cylindrical tubing that is clamped to a cylindrical segment of the body 101 of spray gun 100 by means of a split ring filler tube mounting clamp 134. The filler injection tube 130 has a straight main body section and an approximately 30 degree bend at its short outer end, where it has an outlet 141. If necessary, the tubing of the filler injection tube 130 can be field bent so that it will properly induce the stream of filler into the spray pattern of the spray gun. The material of the filler injection tube 130 is electrically conductive so that a buildup of static electricity on the nozzle is avoided, since it is grounded to the grounded gun body 101 (grounding wires not shown for clarity).

The delivery hose 41 is attached to the filler injection tube 130 by means of standard hose-to-tube connector filler tube attachment fitting 132. The split ring filler tube mounting clamp 134 has a rectangular block body with a first transverse through hole closely fitted to the filler injection nozzle 130. A slot extends radially and horizontally from the first through hole and normally to an adjacent side of the block body, and a through hole perpendicular to the slot and threaded on one side of the slot intersects the slot. A clamp screw extends across the slot and is engaged in the threads of the through hole so that the injector tube 130 can be clamped. A similar second through hole intersected by a similar slot is a close fit to the interior end of the body 101 of gun 100. A through hole perpendicular to and intersecting the slot conventional engages a screw and nut mounted on the opposed end of the mounting clamp body from the first through hole so that the mounting clamp 134 can be positioned on and clamped to the rear portion of the body 101 of the spray gun 100. The clamping by clamp 134 is such that the main portion of the tube of injector tube 130 is held parallel to and offset from the axis of the spray gun 100.

A second embodiment 200 of a spray gun for the filler injection system is shown in FIG. 8. Spray gun 200 utilizes all of the components of the first embodiment 100 of the spray gun, with the exception of the injector tube 130. A modified injector tube 230 having an auxilliary booster nozzle tube 236 is used for the second gun embodiment 200. The booster nozzle tube 236 has a smaller diameter than the main injector tube 230, but has a similarly bent outer end, along with a male threaded section 237 at its opposed end suitable for attachment to an auxiliary air line (not shown). The modified injector tube 230 has a hole coaxial with its outer tip section in which the similarly bent outer end of the booster nozzle tube 236 is coaxially positioned and fixedly mounted in a sealing manner. The outer end of the booster nozzle tube 236 is set inwardly into the main injector tube 230 from its outlet end 141. The booster tube is also supported by a split clamp 240 which engages the outer diameters of both the main injector tube 230 and the booster nozzle tube 236. Basically all other aspects of the two embodiments of the spray gun 100 and 200 and the physical description of the two embodiments 100 and 200 are the same.

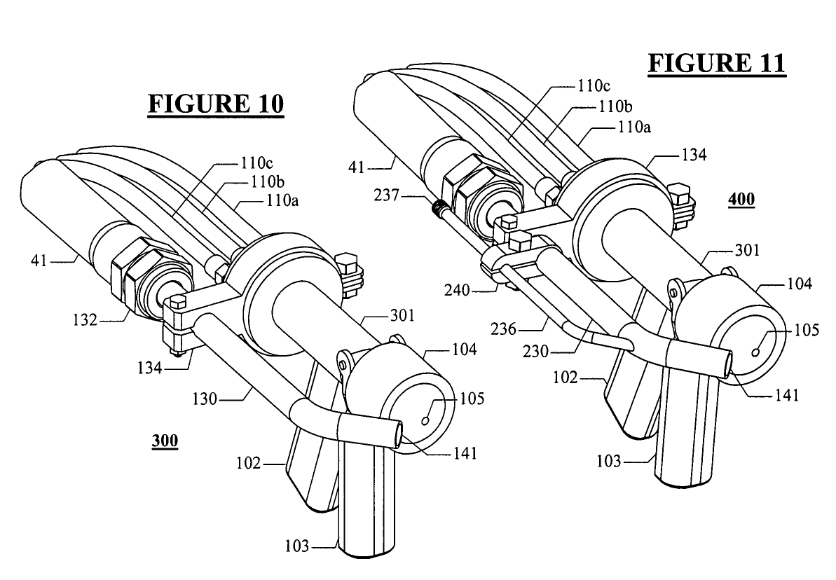

Referring to FIG. 10, the third embodiment of the spray gun 300 is shown. Spray gun 300 is substantially identical to the first spray gun embodiment 100 shown in FIG. 7, with the only difference being that the chopper gun 116 is eliminated from the spray gun body 301 of spray gun 300. Both the third spray gun embodiment 300 and the fourth spray gun embodiment 400 can deliver chopped fiberglass to the resin stream from their respective spray guns 300 and 400, but the delivery is made by means of admixing precut fiberglass skeins with the Renfil™ filler.

The spray gun 300 has a spray gun body 301 which normally has axially aligned stepped cylindrical body segments, a handle 102 projecting in a radial plane, and a trigger 103 attached to the body at one end and rotatable in the same plane of the body defined by the handle. Air, resin, and catalyst are respectively supplied to the rear of the gun 300 by means of hoses 110a,b,c. The hoses 110a,b,c are connected to the rear of the body 301 or gun 300 by threading their end fittings into threaded ports. The threaded ports connect to internal passages and are routed to the mixing head 104 of the body 301 through the flow controlling valving mechanisms of the trigger 103.

The resin and catalyst are combined in the mixing head 104, located at the front of the body 301, and are ejected from the mixing head by means of one or more spray nozzles 105. The resin spray pattern of the gun 300 is substantially coaxial with the cylindrical body segments of the body 301 of gun 300. Since the particular mechanisms of the spray gun control are not part of the present invention and are well known to those skilled in the art, they are not described in detail herein.

The filler injection tube 130 is a length of plastically deformable metallic cylindrical tubing that is clamped to a cylindrical segment of the body 301 of spray gun 300 by means of a split ring filler tube mounting clamp 134. The filler injection tube 130 has a straight main body section and an approximately 30 degree bend at its short outer end, where it has an outlet 141. If necessary, the tubing of the filler injection tube 130 can be field bent so that it will properly induce the stream of filler into the spray pattern of the spray gun. The material of the filler injection tube 130 is electrically conductive so that a buildup of static electricity on the nozzle is avoided, since it is grounded to the grounded gun body 301 (grounding wires not shown for clarity).

The delivery hose 41 is attached to the filler injection tube 130 by means of standard hose-to-tube connector filler tube attachment fitting 132. The split ring filler tube mounting clamp 134 has a rectangular block body with a first transverse through hole closely fitted to the filler injection nozzle 130. A slot extends radially and horizontally from the first through hole and normally to an adjacent side of the block body, and a through hole perpendicular to the slot and threaded on one side of the slot intersects the slot. A clamp screw extends across the slot and is engaged in the threads of the through hole so that the injector tube 130 can be clamped. A similar second through hole intersected by a similar slot is a close fit to the interior end of the body 301 of gun 300. A through hole perpendicular to and intersecting the slot engages a conventional screw and nut mounted on the opposed end of the mounting clamp body from the first through hole so that the mounting clamp 134 can be positioned on and clamped to the rear portion of the body 301 of the spray gun 300. The clamping by clamp 134 is such that the main portion of the tube of injector tube 130 is held parallel to and offset from the axis of the spray gun 300.

A fourth spray gun embodiment 400 for the filler injection system is shown in FIG. 11. Spray gun 400 utilizes all of the components of the third spray gun embodiment 300 of the present invention, with the exception of the injector tube 130. A modified injector tube 230 having an auxilliary booster nozzle tube 236 is used for the fourth gun embodiment. This injector tube 230 is identical to that used for the second spray gun embodiment 200, shown in FIG. 8. The booster nozzle tube 236 has a smaller diameter than the main injector tube 230, but has a similarly bent outer end, along with a male threaded section 237 at its opposed end suitable for attachment to an auxiliary air line (not shown). The modified injector tube 230 has a hole coaxial with its outer tip section in which the similarly bent outer end of the booster nozzle tube 236 is coaxially positioned and is fixedly mounted in a sealing manner. The outer end of the booster nozzle tube 236 is set inwardly into the main injector tube 230 from its outlet end 141. The booster tube is also supported by a split clamp 240 of construction similar to that of clamp 134. Split clamp 240 engages the outer diameters of both the main injector tube 230 and the booster nozzle tube 236. In all other respects, the physical description of the two embodiments 30 and 400 are the same.

### OPERATION OF THE INVENTION

The first embodiment 10 of the present invention operates in the following manner. Air is supplied to one of the spray gun embodiments 100, 200, 300, 0r 400 and to the control system 70. For the purpose of description, the operation of the control system is described for the spray gun 100.

If the spray gun 100 is on and the vibrator override valve is open, then air flows through the control system and to the vibrator 25, the injector nozzle 38, and the air motor 53. When this occurs, the vibrator induces filler in the tank 21 to migrate under gravity to the lower end of the tank and thence into the first pipe nipple 31 of the feed auger system 30. Because the air motor 53 is rotating the auger 35, filler is thereby induced to move toward the injector nozzle 38 by the auger. Since a low pressure is induced by the action of the air flow in the injector nozzle 38, the filler is caused to enter the flow stream from the nozzle 38 and is thereby conveyed through hose 41 to the filler injection tube 130 on the gun 100. The flow of filler mingles with the resin spray emanating from the gun 100 and the chopped fiberglass if the chopper 116 is on so that a homogeneous and intimate mixture of the sprayed components occurs. This intimate mixing at the spray gun of the Renfil™ filler with the sprayed polymer permits a chemical binding reaction between the styrene of the resin and the lignin of the filler, as well as direct absorption of styrene by the filler.

The air pressures of the flows for the venturi nozzle 35 and the air motor 53 are respectively controlled by pneumatic regulators 87 and 89. By this means, the speed of the auger 35 and the transfer rate of filler by the injector nozzle are controlled. The operation of the vibrator 25, the auger 35, and the injector nozzle 38 are normally slaved to the supply of air on the spray gun 100 and hence are controlled by the spray gun operator.

An operator selective control valve 81 with a toggle switch is mounted on control box 71 so that an operator can control the feed of filler independently of the operation of the spray gun 100. The first embodiment 10 of the filler injector system is capable of very high filler deliveries. However, in some cases, the delivery rate is too high for the application. This situation arises because the low pressure of the venturi nozzle 38 is sufficient to draw filler from tank 21 without the turning of the auger 35. For this reason, the adjustable regulator 87 serves to maintain a proper feed rate of filler. Additionally, the restrictor orifice plate 49, seen in FIG. 6, also controls the admission of filler into the injector nozzle 38. Furthermore, the excess flow tee connection branch operates to return excess filler to the tank, thereby assisting to maintain a stable filler delivery to the spray gun 100, 200, 300 or 400 and control on the amount of filler delivered to the gun.

The operation of the first spray gun embodiment 100 is as follows. Depressing the trigger 103 of the spray gun 100 causes air delivered to the gun to mix resin and delivery air in the mixing head 104 of the gun and expel it in a stream from nozzle 105. If the chopper gun 116 is turned on by means of chopper gun switching valve 119, then chopped segments of fiberglass skein are also delivered into the resin stream emerging from nozzle 105. If manual override valve 81 is turned on, then the delivery hose conveys filler from the filler injection system 10 through hose 41 and filler injection tube 130 to the resin stream from the nozzle 105 of gun 100. There the filler is thoroughly admixed with the resin stream and the excess styrene in the resin is captured by the Renfil™. Turning off the switching valve 119 causes the filler stream and the fiberglass from the chopper gun both to stop flowing. This permits neat resin to be sprayed as a gel coat or as a final layer during the layup process.

Operation of the second spray gun embodiment 200 is similar to that of the first spray gun 100, with the exception that a high velocity air stream from the booster nozzle tube 236 is used to increase velocity of the filler emerging from the filler injector tube 230. This velocity increase enhances the mixing of the filler stream with the resin stream emerging from nozzle 105. Although it is not shown herein, the air supply to the booster nozzle tube 236 can be controlled by valve 88 so that the booster air stream can be turned on and off when needed.

The third spray gun embodiment 300 is used when only the particulate material from the tank 21 is sprayed into the resin stream. For example, Renfil™ filler, precut fiberglass skeins, or a mixture of Renfil™ and precut fiberglass may be sprayed into the resin. Because the combination of the Renfil™ filler with the precut fiberglass can have well controlled component ratios, it is not necessary to use a chopper gun 116 on the spray gun 300. In all other respects, the operation of the system is identical with that of the first spray gun embodiment 100.

The fourth spray gun embodiment 400 likewise is used when only particulate material from the tank 21 is used, such as the Renfil™ filler premixed with precut fiberglass skeins. The spray guns 300 and 400 are substantially identical in structure and operation, with the exception that the booster tube 236 is used with gun 400. The operation of the booster tube 236 with the filler injector tube 230 is identical for both spray gun embodiments 200 and 400.

### ADVANTAGES OF THE INVENTION

A major advantage of the present invention is the ability to ensure adequate delivery of and carefully control the rate of filler injection into the resin stream. This rate of filler injection is controlled and ensured by first providing an amount of filler with the feed auger system 30 which is adequate or somewhat in excess of adequate for supply to the spraygun 100, 200, 300 or 400. The delivery restrictor orifice 49 is preselected to limit the amount of filler available to the injector nozzle 38 as a function of the vacuum induced by the air injection holes in the sleeve 47 of the injector nozzle 38. The vacuum induced by the injector nozzle 38 is readily adjustable to control injector nozzle 38 flow rate to compensate for any desired changes in filler amounts in the sprayed resin or other factors. This is accomplished by reducing or raising the pressure of the pressure regulator 87 in the control box 70.

The feed auger system 30, aided by the vacuum of the injector nozzle 38, is able to deliver much more filler than competitive systems. The level of vacuum provided by the injector nozzle 38 is adjusted so that more filler is entrained by the venturi action than is delivered to the injector nozzle by the combination of the venturi action and the auger.

The different spray gun embodiments permit chopped fiberglass to be added to the resin stream from the spray guns by using a separate chopper gun integral with the spray gun or by adding chopped fiberglass into the tank 21, either alone or admixing the fiberglass with some other particulate material. The addition of the booster tube 236 to a modified filler injection tube 130 is used in cases when enhanced filler exit velocity is desirable to ensure better mixing of the filler with the sprayed resin stream.

The system may be modified from its disclosed form without departing from the spirit of the invention. For instance, a variable speed electric motor or a hydraulic motor can be used instead of the air motor 53 shown herein. Likewise, the air motor or an electric motor can be provided with a reduction gear box to increase auger torque. The choice of pipe fitting used in the system and the described sizes of fittings can be varied without departing from the spirit of the invention. It is believed that other modifications, variations, and changes will be suggested to those skilled in the art in view of the description set forth above. The structure of the injector nozzle 38 can be varied without departing from its basic operation as a venturi inductor. It is therefore to be understood that all such variations, modifications, and changes are believed to fall within the scope of the invention as defined in the appended claims.

What is claimed is:

1. An apparatus for spraying particulate matter and resin comprising:
(a) an air supply;
(b) a particulate feed system having
an air motor in communication with the air supply,
an auger rotated by the air motor,
a supply tank feeding a particulate material into the auger, and
a venturi nozzle, wherein rotation of the auger delivers the particulate material to the venturi nozzle and the particulate material emanates from the venturi nozzle; and
(c) a spray gun delivering a resin stream and a stream of the particulate material.

2. The apparatus of claim 1, further comprising a control system for controlling the delivery of the resin stream and the stream of the particulate material by controlling a rotation rate of the auger and a venturi air supply pressure.

3. The apparatus of claim 1, wherein the particulate feed system further comprises a vibrator to assist the flow of the particulate material from the supply tank into the auger.

4. The apparatus of claim 1, wherein the particulate feed system further comprises a counting means for counting a number of auger rotations.

5. The apparatus of claim 1, further comprising a valve for controlling air volume delivered to the venturi nozzle.

6. The apparatus of claim 1, wherein the spray gun comprises
a spray gun body,
a mixing head,
a spray nozzle in communication with the mixing head, and
a particulate injection nozzle in communication with the venturi nozzle.

7. The apparatus of claim 1, wherein the spray gun comprises
a spray gun body,
a mixing head,
a spray nozzle in communication with the mixing head,
a chopper gun,
a chopper nozzle, and
a particulate injection nozzle in communication with the venturi nozzle.

8. The apparatus of claim 7, wherein a stream of chopped glass emanates from the chopper nozzle, the resin stream emanates from the spray nozzle, and the stream of particulate material emanates from the particulate injection nozzle.

9. The apparatus of claim 8, wherein the resin stream, the chopped glass stream, and the stream of particulate material are mixed together during spraying.

10. The apparatus of claim 1, further comprising an injection control means for controlling the delivery of the resin stream and the stream of particulate material.

11. An apparatus for spraying reinforced plastic resin comprising:
(a) an air supply;
(b) a filler feed system having
an air motor in communication with the air supply,
an auger rotated by the air motor,
a filler supply tank feeding a filler material into the auger, and
a venturi nozzle, wherein rotation of the auger delivers the filler material to the venturi nozzle and the filler material emanates from the venturi nozzle at a rate controlled by a rate of rotation of the auger and the venturi air supply pressure; and
(c) a spray gun delivering a resin stream, a chopped glass stream, and a stream of filler material.

12. The apparatus of claim 11, wherein the spray gun includes
a spray gun body,
a mixing head,
a spray nozzle in communication with the mixing head,
a chopper gun,
a chopper nozzle, and
a filler injection nozzle in communication with the venturi nozzle.

13. An apparatus for spraying particulate matter and resin comprising:
(a) an air supply;
(b) a particulate feed system having
an air motor in communication with the air supply,
an auger rotated by the air motor,
a supply tank feeding a particulate material into the auger, and
a venturi nozzle, wherein rotation of the auger delivers the particulate material to the venturi nozzle and the particulate material emanates from the venturi nozzle; and
(c) a spray gun delivering a resin stream and a stream of the particulate material, the spay gun comprising
a spray gun body,
a mixing head,
a spray nozzle in communication with the mixing head, and
a particulate injection nozzle in communication with the venturi nozzle; and
(d) a control means for controlling the delivery of the stream of the particulate material by controlling a rotation rate of the auger and a venturi air supply pressure.

14. The apparatus of claim 13, wherein the spray gun further comprises a chopper gun and a chopper nozzle.

15. The apparatus of claim 13, wherein the particulate feed system further comprises a vibrator to assist the flow of the particulate material from the supply tank into the auger.

16. The apparatus of claim 13, wherein the particulate feed system further comprises a counting means for counting a number of auger rotations.

17. The apparatus of claim 13, further comprising a valve for controlling air volume delivered to the venturi nozzle.

18. The apparatus of claim 13, wherein the auger is flexible.

19. A process for spraying reinforced plastic resin using the apparatus of claim 1.

20. The process of claim 19, wherein the particulate material is a natural fiber, a chopped glass, or a mixture of fiber and glass.

21. The process of claim 20, wherein the natural fiber has a high lignin content.

22. The process of claim 19 further comprising the step of controlling a rate of delivery of the resin stream and the stream of the particulate material.
